(19) United States
(12) Patent Application Publication
(10) Pub. No.: US 2003/0110234 A1
(43) Pub. Date: Jun. 12, 2003

(54) System and methodology for delivering media to multiple disparate client devices based on their capabilities

(75) Inventors: Paul A. Egli, Scotts Valley, CA (US); Shekhar Kirani, Capitola (IN); Venkat V. Easwar, Cupertino, CA (US)

Correspondence Address: JOHN A. SMART, 708 BLOSSOM HILL RD., #201, LOS GATOS, CA, 95032, US

(73) Assignee: LightSurf Technologies, Inc.

(21) Appl. No.: 10/010,616

(22) Filed: Nov. 8, 2001

(51) Int. Cl. G06F 15/16

(52) U.S. Cl. 709/217

(57) ABSTRACT

An online media delivery system incorporating combining on-the-fly media reformatting with advanced client detection capabilities enabling delivery of appropriate media content to connected client devices is described. The system receives requests from client devices for media documents or objects, identifies the client device requesting particular media objects from an HTTP request, determines the media output capabilities of the client device, reformats the source media according to those capabilities and delivers the reformatted media to the client device. The system provides access to media content for multiple disparate client devices of varying hardware and software capabilities. The system enables delivery of appropriate media content to practically any device with connectivity capability.

### RELATED APPLICATIONS

The present application is related to the following commonly-owned application(s): application Ser. No. 09/588,875 (Docket No. LS/0003.01), filed Jun. 6, 2000, entitled “System and Methodology Providing Access to Photographic Images and Attributes for Multiple Disparate Client Devices”; and application Ser. No. 09/489,511 (Docket No. LS/0002.00), filed Jan. 21, 2000, entitled “Improved Digital Camera Device with Methodology for Efficient Color Conversion”. The disclosures of each of the foregoing applications are hereby incorporated by reference in their entirety, including any appendices or attachments thereof, for all purposes.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### COMPUTER PROGRAM LISTING APPENDIX

A Computer Program Listing Appendix A containing computer program listings is included with this application. The disclosure of the Computer Program Listing Appendix A is hereby incorporated by reference.

### BACKGROUND OF THE INVENTION

The present invention relates generally to information processing and, more particularly, to an online system providing methodology for improving online access to digital media and related information.

A variety of digital image, digital video and digital audio products are currently available to consumers. Regardless of how digital media is recorded, at some later point in time, the information must become available to other devices—that is, become available to a larger network of digital devices, so that such information may be displayed on a screen, printed to hard copy, stored, or shared with other people. Today, a large number of Web sites exist on the Internet with server computers having the capability to organize and display images, video, audio, and other types of media and digital objects. In a complementary manner, a multitude of different client devices exist with sufficient graphics capabilities for potentially viewing (and/or listening to) this media. For instance, such client devices range from desktop or laptop computers running Web browser software to handheld devices (e.g., personal digital assistants running under Palm or Windows CE), all connected to the Internet over TCP/IP, each with the capability of displaying information.

More recently, a newer class of devices has been introduced with wireless data capabilities as well as display capabilities. These devices connect to the Internet typically over WAP (Wireless Application Protocol). WAP is a communication protocol, not unlike TCP/IP, that was developed by a consortium of wireless companies, including Motorola, Ericsson, and Nokia, for transmitting data over wireless networks. For a description of WAP, see e.g., Mann, S., The Wireless Application Protocol, Dr. Dobb's Journal, pp. 56-66, October 1999, the disclosure of which is hereby incorporated by reference.

All told, a plethora of graphics-equipped devices exist today that may be connected to the Internet, through both wireless (e.g., 9600 baud) and wireline connections (e.g., 56 k baud, DSL, and cable modem). These devices are capable of displaying graphics, including digital images. Recent advances in handheld computing and wireless technologies have enabled manufacturers to embed or include Web browsers in a wide array of devices, including palm-type organizers, wireless phones, and two-way pagers. While all of these Web-enabled clients are capable of at least rudimentary display of text, some also support various multimedia content such as images, video, and sound. Faster wireless Internet access will drive development of client devices capable of playing larger, richer media formats.

However, a fundamental problem exists with current approaches to displaying images and other digital media on many of these devices. Some devices such as personal or laptop computers are capable of receiving and rendering a number of different types of media, including digital images, streaming audio, and streaming video. However, other devices have much more limited capabilities to render digital media. In addition, different devices often support different formats and communication transport protocols.

Consider, for instance, the example of a Palm handheld device. Suppose a user has a “true-color” (e.g., 32-bit depth) 1024 by 768 digital photograph of his or her family on the Web. If the user connects to the Internet using the Palm device, he or she cannot display the photograph because the Palm device may only support four-level or sixteen-level grayscale. Even if the image could be displayed, the transmission time for downloading the image to the Palm device would be impractical. Still further, even if the image could be downloaded, the display for the Palm may be physically too small to render the image in a manner that is acceptable to the user.

This problem is not limited to just image data but also applies to other types of digital objects. Many Internet sites display multi-colored images, streaming video, streaming audio, and other content that is targeted primarily at users with desktop and laptop computer devices and Web browser software. A desktop or laptop computer has significant processing, storage, and display resources and is capable of rendering large images and video files in multiple colors and formats. On the other hand, a smaller device such as a cellular phone or a personal digital assistant (“PDA”) typically does not have the necessary capabilities to display colors or to handle media in particular formats. For example, a cellular phone, which typically has a small screen for display of messages, does not have the software or display capabilities to render a JPEG image. Currently, a user with a PDA or cellphone is typically unable to access much of the information available on many Internet sites.

Certain content providers that are focused primarily on cellular telephone and PDA users do offer Internet sites that display media appropriate for these users. These sites include images with lower resolution and fewer colors in formats supported by these types of devices. However, even content providers focused on cellular telephone and handheld device users have problems supporting the wide number of devices currently in use. Numerous different types of cellular telephones and handheld devices are in use, each having different specifications and capabilities. These devices have different screen sizes, resolution, and color capabilities. Thus, even if a content provider is focused on cellular telephone users, that content provider often must create images and other media offerings geared towards the least capable devices in order to serve the broadest number of users.

Another particular problem in the delivery of media to wireless users is limited bandwidth. In addition to the image display and audio output limitations of many wireless devices, the available bandwidth also limits the ability of these devices to access and use richer media formats. Thus even for devices with better audio and video capabilities, bandwidth considerations may still significantly constrain the types of media that may be supplied to these devices. Even if a user's wireless device is capable of displaying a high-resolution image, he or she may request a lower resolution image because of the time required to download the image given the limited available bandwidth.

In addition to these problems stemming from limited bandwidth and display resources available to many wireless devices, another problem is that present-day Internet services do not attempt to understand the capabilities of particular connected devices. Moreover, even if such Internet services understand some of the capabilities of a particular client device, present-day servers are not designed to act on that information and transmit information only in the format that is meaningful for such client device. As more and more classes of network-connected devices come to market, this problem can be expected to grow as each device has its own particular characteristics.

What is needed is a solution that combines on-the-fly media reformatting with advanced client detection to enable the delivery of the appropriate and best possible incarnation of a provider's media to every connected client device. The present invention fulfills this and other needs.

### Glossary

The following definitions are offered for purposes of illustration, not limitation, in order to assist with understanding the discussion that follows.

Apache: Apache is a public domain Web server developed by a group of volunteer programmers called the Apache Group. The initial version of the Apache server was developed in 1995 based on the httpd Web server developed at the National Center for Supercomputing Applications, University of Illinois, Urbana-Champaign. Additional information on the Apache Web server and copies of the source code for this Web server are currently available on the Internet at http://www.apache.org.

CC/PP: CC/PP is an abbreviation for Composite Capabilities/Preference Profiles, a proposed standard being developed by the World Wide Web Consortium (W3C). A CC/PP profile is a description of device capabilities and user preferences that can be used to guide the adaptation of content presented to that device. The current proposed specification is described by “Composite Capability/Preference Profiles (CC/PP): A user side framework for content negotiation”, W3C Note, 27 July 1999, available from the World Wide Web Consortium (W3C), the disclosure of which is hereby incorporated by reference. A copy of the proposed standard can be currently found on the Internet at http://www.w3.org/TR/NOTE-CCPP/.

HTML: HTML stands for HyperText Markup Language. Every HTML document requires certain standard HTML tags in order to be correctly interpreted by Web browsers. Each document consists of head and body text. The head contains the title, and the body contains the actual text that is made up of paragraphs, lists, and other elements. Browsers expect specific information because they are programmed according to HTML and SGML specifications. Further description of HTML documents is available in the technical and trade literature; see e.g., Ray Duncan, Power Programming: An HTML Primer, PC Magazine, Jun. 13, 1995, the disclosure of which is hereby incorporated by reference.

HTTP: HTTP stands for HyperText Transfer Protocol, which is the underlying communication protocol used by the World Wide Web on the Internet. HTTP defines how messages are formatted and transmitted, and what actions Web servers and browsers should take in response to various commands. For example, when a user enters a URL in his or her browser, this actually sends an HTTP command to the Web server directing it to fetch and transmit the requested Web page. Further description of HTTP is available in RFC 2616: Hypertext Transfer Protocol—HTTP/1.1, the disclosure of which is hereby incorporated by reference. RFC 2616 is available from the World Wide Web Consortium (W3 C), and is currently available via the Internet at http://www.w3.org/Protocols/. Additional description of HTTP is available in the technical and trade literature; see e.g., William Stallings, The Backbone of the Web, BYTE, October 1996, the disclosure of which is hereby incorporated by reference.

JPEG: Full-size digital images are maintained in a Joint Photographic Experts Group or JPEG format. See e.g., Nelson, M. et al., The Data Compression Book, Second Edition, Chapter 11: Lossy Graphics Compression (particularly at pp. 326-330), M&T Books, 1996. Also see e.g., JPEG-like Image Compression (Parts 1 and 2), Dr. Dobb's Journal, July 1995 and August 1995 respectively (available on CD ROM as Dr. Dobb's/CD Release 6 from Dr. Dobb's Journal of San Mateo, Calif.). The disclosures of the foregoing are hereby incorporated by reference.

SMTP: SMTP stands for Simple Mail Transfer Protocol, a protocol for sending e-mail messages between servers. Most e-mail systems that send mail over the Internet use SMTP to send messages from one server to another; the messages can then be retrieved with an e-mail client using either POP or IMAP. In addition, SMTP is generally used to send messages from a mail client to a mail server.

TCP: TCP stands for Transmission Control Protocol. TCP is one of the main protocols in TCP/IP networks. Whereas the IP protocol deals only with packets, TCP enables two hosts to establish a connection and exchange streams of data. TCP guarantees delivery of data and also guarantees that packets will be delivered in the same order in which they were sent. For an introduction to TCP, see, e.g., RFC 793, the disclosure of which is hereby incorporated by reference.

TCP/IP: Stands for Transmission Control Protocol/Internet Protocol, the suite of communications protocols used to connect hosts on the Internet. TCP/IP uses several protocols, the two main ones being TCP and IP. TCP/IP is built into the UNIX operating system and is used by the Internet, making it the de facto standard for transmitting data over networks. For an introduction to TCP/IP, see e.g., RFC 1180: A TCP/IP Tutorial, the disclosure of which is hereby incorporated by reference. A copy of RFC 1180 is currently available at ftp://ftp.isi.edu/in-notes/rfc1180.txt.

UAProf: UAProf or WAG UAProf refers to the proposed Wireless Access Group User Agent Profile Specification about how devices such as cellular phones should describe their capabilities to servers. The current proposed specification is described as “WAG UAProf” (Wireless Application Group User Agent Profile Specification), Wireless Application Protocol Forum, Ltd., Proposed Version May 30, 2001, available from the WAP Forum, the disclosure of which is hereby incorporated by reference. A copy of the specification can currently be found on the Internet at http://www1.wapforum.org/tech/documents/WAP-248-UAProf-20010530-p.pdf.

URL: Abbreviation of Uniform Resource Locator, the global address of documents and other resources on the World Wide Web. The first part of the address indicates what protocol to use, and the second part specifies the IP address or the domain name where the resource is located.

WAP: WAP stands for Wireless Application Protocol, which is a communication protocol, not unlike TCP/IP, that was developed by a consortium of wireless companies, including Motorola, Ericsson, and Nokia, for transmitting data over wireless networks. For a description of WAP, see e.g., Mann, S., The Wireless Application Protocol, Dr. Dobb's Journal, pp. 56-66, October 1999, the disclosure of which is hereby incorporated by reference. More particularly, WAP includes various equivalents of existing Internet protocols. For instance, WML is a WAP version of the HTML protocol. Other examples include a WAP browser that is a WAP equivalent of an HTML browser and a WAP gateway (on the server side) that is a WAP equivalent of an HTTP server. At the WAP gateway, HTTP is translated to/from WAP.

XML: Short for Extensible Markup Language, a specification developed by the W3C. XML is a pared-down version of SGML, designed especially for Web documents. It allows designers to create their own customized tags, enabling the definition, transmission, validation, and interpretation of data between applications and between organizations. For further description of XML, see, e.g., Extensible Markup Language (XML) 1.0 specification which is available from the World Wide Web Consortium (www.w3.org), the disclosure of which is hereby incorporated by reference. The specification is also currently available on the Internet at http://www.w3.org/TRIREC-xml.

### SUMMARY OF THE INVENTION

The present invention provides an online system incorporating improved methodologies enabling content providers to effectively serve the widest array of clients. It combines on-the-fly media reformatting with advanced client detection capabilities to enable the delivery of the appropriate and best possible incarnation of a provider's media content to every connected client device.

The online media delivery system of the present invention (commercially embodied in eSwitch™-brand media delivery system) receives requests from client devices for media documents or objects, determines the media output capabilities of the device making the request, and serves a transformed version of the media object appropriate for the requesting client device. The system includes a client capabilities module (CCM) and a media transformation module (MTM). These two modules cooperate to identify a client from an HTTP request, determine its media output capabilities, and reformat the source media according to those capabilities. The system also includes a data store containing information on the capabilities of various client devices, an (optional) front-side cache for storing transformed media content, and a backside cache for local storage of original items of content.

The system provides access to media content for multiple disparate client devices—that is, to target devices of varying hardware and software capabilities. The system enables delivery of appropriate media content to practically any device with connectivity capability. The target devices may include both wireless devices (e.g., cellular phone, handheld personal digital assistant (PDA), and pager) as well as wireline devices (e.g., desktop computer, laptop computer, and videophone).

The improved methodology of the system in providing media content appropriate to a particular device can be summarized as follows. Initially, the URLs of particular full-format multimedia objects on an Internet Web site are modified to be served by the system of the present invention. This is accomplished by modifying the HTML pages on the Web site to replace the URLs of these full-format multimedia objects with URLs which point to the server on which the media delivery system is installed and contains the path to the media objects. The system acts as an HTTP proxy to those original objects, intercepting requests for the original content and serving a transformed version of the content applicable to the requesting client.

When a client device receives user input (e.g., a click) invoking the modified URL for requesting a particular multimedia document, the media output capabilities are communicated to the system by the device or are surmised by the system's client capabilities module. If the device is communicating its capabilities, it does so during the initiation or during every interaction. Alternatively, the device's capabilities are previously stored in the system's data store based on prior knowledge of the device. Based on the information communicated to or surmised by the system, an information record is created describing the target device's capabilities. This information indicates to the system what transformation (if any) is required for translating the original item of media content into a format suitable for the target device.

After the appropriate media format required by the device is determined, the client capabilities module (optionally) checks the front-side cache to see whether the cache already stores a version of the object that has been translated into a format suitable for this particular target device. If the object (transformed for the target device) already exists in the front-side cache, then the client capabilities module may simply return that object to the client device. However, if an appropriate transformed object is not in the cache, then the client capabilities module proceeds to pass the object identifier and the client device parameters on to the media transformation module.

The media transformation module receives requests for a particular item of media content in a particular format from the client capabilities module. The media transformation module obtains the original media object, transforms the object from its original format into the format that is desired for the target device (based on the specified target device capabilities), and returns the converted object to the client device. The media transformation module utilizes a backside cache as an optimization to provide increased efficiency. Media objects are retained in the backside cache to avoid having to retrieve frequently or recently requested items in response to each request. Use of this backside cache reduces the number of calls over the network and expedites conversion and return of media objects to client devices.

### BRIEF DESCRIPTION OF THE DRAWINGS

FIG. 1 is a block diagram of a computer system in which software-implemented processes of the present invention may be embodied.

FIG. 2 is a block diagram of a software system for controlling the operation of the computer system.

FIG. 3 is a block diagram illustrating an online media delivery system of the present invention.

FIGS. 4A-B comprise a single flowchart illustrating the detailed method steps of the system in determining the capabilities of a target device and transforming and delivering content to such target device in an appropriate format.

FIG. 5 is a flowchart illustrating the operations of the client capabilities module of the present invention in acting as a proxy for incoming HTTP requests from non-compliant devices.

### DETAILED DESCRIPTION OF A PREFERRED EMBODIMENT

The following description will focus on the presently-preferred embodiment of the present invention, which is implemented in a desktop application operating in an Internet-connected environment running under a desktop operating system, such as the Microsoft® Windows operating system running on an IBM-compatible PC. The present invention, however, is not limited to any one particular application or any particular environment. Instead, those skilled in the art will find that the system and methods of the present invention may be advantageously embodied on a variety of different platforms, including Macintosh, Linux, BeOS, Solaris, UNIX, NextStep, FreeBSD, and the like. Therefore, the description of the exemplary embodiments that follows is for purposes of illustration and not limitation.

I. Computer-Based Implementation

A. Basic System Hardware (e.g., for Desktop and Server Computers)

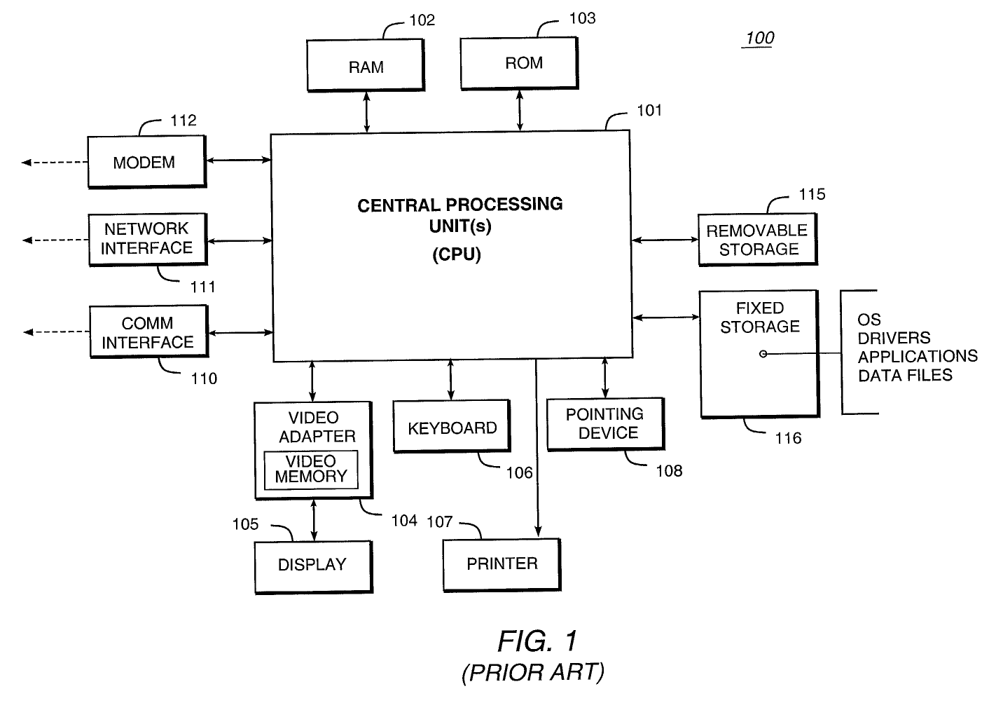

The present invention may be implemented on a conventional or general-purpose computer system, such as an IBM-compatible personal computer (PC) or server computer. FIG. 1 is a very general block diagram of an IBM-compatible system 100. As shown, system 100 comprises a central processing unit(s) (CPU) or processor(s) 101 coupled to a random-access memory (RAM) 102, a read-only memory (ROM) 103, a keyboard 106, a printer 107, a pointing device 108, a display or video adapter 104 connected to a display device 105, a removable (mass) storage device 115 (e.g., floppy disk, CD-ROM, CD-R, CD-RW, DVD, or the like), a fixed (mass) storage device 116 (e.g., hard disk), a communication (COMM) port(s) or interface(s) 110, a modem 112, and a network interface card (NIC) or controller 111 (e.g., Ethernet). Although not shown separately, a real-time system clock is included with the system 100, in a conventional manner.

CPU 101 comprises a processor of the Intel Pentium® family of microprocessors. However, any other suitable processor may be utilized for implementing the present invention. The CPU 101 communicates with other components of the system via a bi-directional system bus (including any necessary input/output (I/O) controller circuitry and other “glue” logic). The bus, which includes address lines for addressing system memory, provides data transfer between and among the various components. Description of Pentium-class microprocessors and their instruction set, bus architecture, and control lines is available from Intel Corporation of Santa Clara, Calif. Random-access memory 102 serves as the working memory for the CPU 101. In a typical configuration, RAM of sixty-four megabytes or more is employed. More or less memory may be used without departing from the scope of the present invention. The read-only memory (ROM) 103 contains the basic input/output system code (BIOS)—a set of low-level routines in the ROM that application programs and the operating systems can use to interact with the hardware, including reading characters from the keyboard, outputting characters to printers, and so forth.

Mass storage devices 115, 116 provide persistent storage on fixed and removable media, such as magnetic, optical or magnetic-optical storage systems, flash memory, or any other available mass storage technology. The mass storage may be shared on a network, or it may be a dedicated mass storage. As shown in FIG. 1, fixed storage 116 stores a body of program and data for directing operation of the computer system, including an operating system, user application programs, driver and other support files, as well as other data files of all sorts. Typically, the fixed storage 116 serves as the main hard disk for the system.

In basic operation, program logic (including that which implements methodology of the present invention described below) is loaded from the removable storage 115 or fixed storage 116 into the main (RAM) memory 102, for execution by the CPU 101. During operation of the program logic, the system 100 accepts user input from a keyboard 106 and pointing device 108, as well as speech-based input from a voice recognition system (not shown). The keyboard 106 permits selection of application programs, entry of keyboard-based input or data, and selection and manipulation of individual data objects displayed on the screen or display device 105. Likewise, the pointing device 108, such as a mouse, track ball, pen device, or the like, permits selection and manipulation of objects on the display screen. In this manner, these input devices support manual user input for any process running on the system.

The computer system 100 displays text and/or graphic images and other data on the display device 105. The video adapter 104, which is interposed between the display 105 and the system/s bus, drives the display device 105. The video adapter 104, which includes video memory accessible to the CPU 101, provides circuitry that converts pixel data stored in the video memory to a raster signal suitable for use by a cathode ray tube (CRT) raster or liquid crystal display (LCD) monitor. A hard copy of the displayed information, or other information within the system 100, may be obtained from the printer 107, or other output device. Printer 107 may include, for instance, an BP LaserJet® printer (available from Hewlett-Packard of Palo Alto, Calif.), for creating hard copy images of output of the system.

The system itself communicates with other devices (e.g., other computers) via the network interface card (NIC) 111 connected to a network (e.g., Ethernet network, Bluetooth wireless network, or the like), and/or modem 112 (e.g., 56K baud, ISDN, DSL, or cable modem), examples of which are available from 3Com of Santa Clara, Calif. The system 100 may also communicate with local occasionally-connected devices (e.g., serial cable-linked devices) via the communication (COMM) interface 110, which may include a RS-232 serial port, a Universal Serial Bus (USB) interface, or the like. Devices that will be commonly connected locally to the interface 110 include laptop computers, handheld organizers, digital cameras, and the like.

IBM-compatible personal computers and server computers are available from a variety of vendors. Representative vendors include Dell Computers of Round Rock, Tex., Compaq Computers of Houston, Tex., and IBM of Armonk, N.Y. Other suitable computers include Apple-compatible computers (e.g., Macintosh), which are available from Apple Computer of Cupertino, Calif., and Sun Solaris workstations, which are available from Sun Microsystems of Mountain View, Calif.

B. Basic System Software

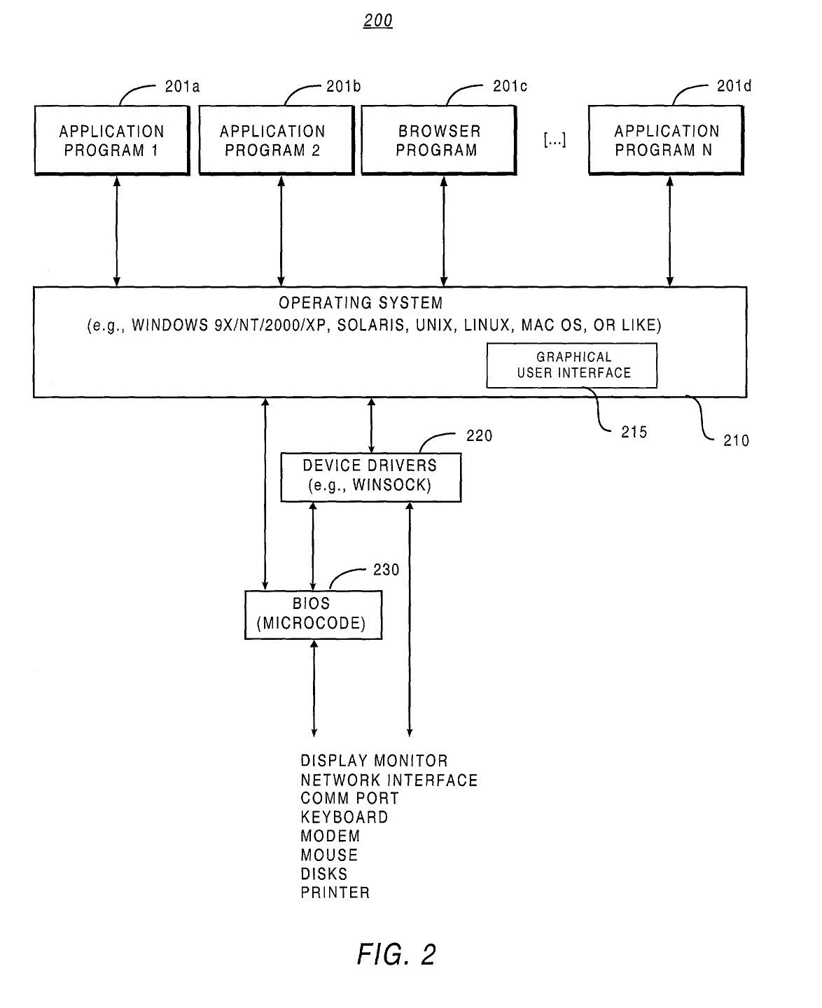

Illustrated in FIG. 2, a computer software system 200 is provided for directing the operation of the computer system 100. Software system 200, which is stored in system memory (RAM) 102 and on fixed storage (e.g., hard disk) 116, includes a kernel or operating system (OS) 210. The OS 210 manages low-level aspects of computer operation, including managing execution of processes, memory allocation, file input and output (I/O), and device I/O. One or more application programs, such as client application software or “programs” 201 (e.g., 201a, 201b, 201c, 201d) may be “loaded” (i.e., transferred from fixed storage 116 into memory 102) for execution by the system 100.

System 200 includes a graphical user interface (GUI) 215, for receiving user commands and data in a graphical (e.g., “point-and-click”) fashion. These inputs, in turn, may be acted upon by the system 100 in accordance with instructions from operating system 210, and/or client application module(s) 201. The GUI 215 also serves to display the results of operation from the OS 210 and application(s) 201, whereupon the user may supply additional inputs or terminate the session. Typically, the OS 210 operates in conjunction with device drivers 220 (e.g., “Winsock” driver—Windows' implementation of a TCP/IP stack) and the system BIOS microcode 230 (i.e., ROM-based microcode), particularly when interfacing with peripheral devices. OS 210 can be provided by a conventional operating system, such as Microsoft® Windows 9x, Microsoft® Windows NT, Microsoft® Windows 2000, or Microsoft® Windows XP, all available from Microsoft Corporation of Redmond, Wash. Alternatively, OS 210 can also be an alternative operating system, such as the previously-mentioned operating systems.

The above-described computer hardware and software are presented for purposes of illustrating the basic underlying desktop and server computer components that may be employed for implementing the present invention. For purposes of discussion, the following description will present examples in which it will be assumed that there exists a “server” (e.g., Web server) that communicates with one or more “clients” (e.g., media display devices). The present invention, however, is not limited to any particular environment or device configuration. In particular, a client/server distinction is not necessary to the invention, but is used to provide a framework for discussion. Instead, the present invention may be implemented in any type of system architecture or processing environment capable of supporting the methodologies of the present invention presented in detail below.

II. Online Rendering of Media Tailored to Capabilities of Various Devices

A. Introduction

Today, a great volume of various types of media content is available on a multitude of Internet sites. At the same time, a wide range of target devices exist that are capable of displaying (rendering) media to users. These devices include personal computers, laptop computers, personal digital assistants (PDAs), two-way pagers, and cellular telephones. However, several problems exist in the delivery of media content to these devices. Given the vastly different capabilities of the various target devices in use and the different types of images and other media content available on the Internet, content providers currently have problems delivering media content in a manner suitable for display (or rendering) to the user of a particular target device in a satisfactory manner.

One solution for these problems is for an Internet site to display information in a number of different formats. However, this solution requires an Internet content provider to display a large number of copies of the same media object in order to address the various types of devices on the market and their wide range of capabilities. Among the disadvantages of this approach are that it requires the content provider to create, store, and manage multiple pre-rendered versions of the same media in various formats depending on the number of devices to be supported.

The present invention allows a content provider to develop content in one form and deliver the content in multiple forms based on the capabilities of the client device requesting the content. The present invention includes an online system and methodology for providing a client device with media content appropriate for the media output capabilities of the device. The system includes a client capabilities module (CCM) to determine the capabilities of connected client devices and a media transformation (or transcoding) module (MTM) that renders the appropriate media on-the-fly and delivers it to the client device in the appropriate format.

The operations of the present invention can be illustrated by the following example of rendering a digital image to a particular client device. In this example, the original item of media content on an Internet site is a 24-bit color JPEG image and the client device requesting this image is a Palm PDA that supports 16-level grayscale. The client device connects wirelessly to the Internet site and invokes the URL for this JPEG image. The Internet content provider using the present invention has previously revised the Uniform Resource Locator (URL) for this image to refer to the machine on which the client capabilities module of the present invention is installed. As a result, this URL request is routed to the CCM, which identifies the requested image and the client device from this request. The CCM determines the capabilities of the client device in an intelligent fashion by examining the client request to the server to obtain information about the client device and by comparing this information to known device characteristics and capabilities stored in its data store. In this case, the CCM recognizes this device as a specific type of Palm PDA and looks up the device's capabilities in the system's database. Based upon this information, the CCM determines that the JPEG image should be supplied to this Palm device in a 16-level grayscale format.

After the appropriate media format required by the device is determined, the CCM (optionally) checks a front-side cache to see whether the cache already stores a version of the image in the required format. If an appropriate transformed image is not in the cache, then the CCM requests the image from the media transformation module in a 16-level grayscale format suitable for rendering to this type of Palm PDA device. The MTM obtains the appropriate image, converts it to the appropriate format and serves it to the client device. The system includes intelligence that allows it to optimally translate the images (from their original format) into a format suitable for use by the particular target device. The overall translation or transformation process is performed in a manner that preserves performance and scalability criteria desired for the system.

B. Overview of Media Delivery System

1. Basic Architecture

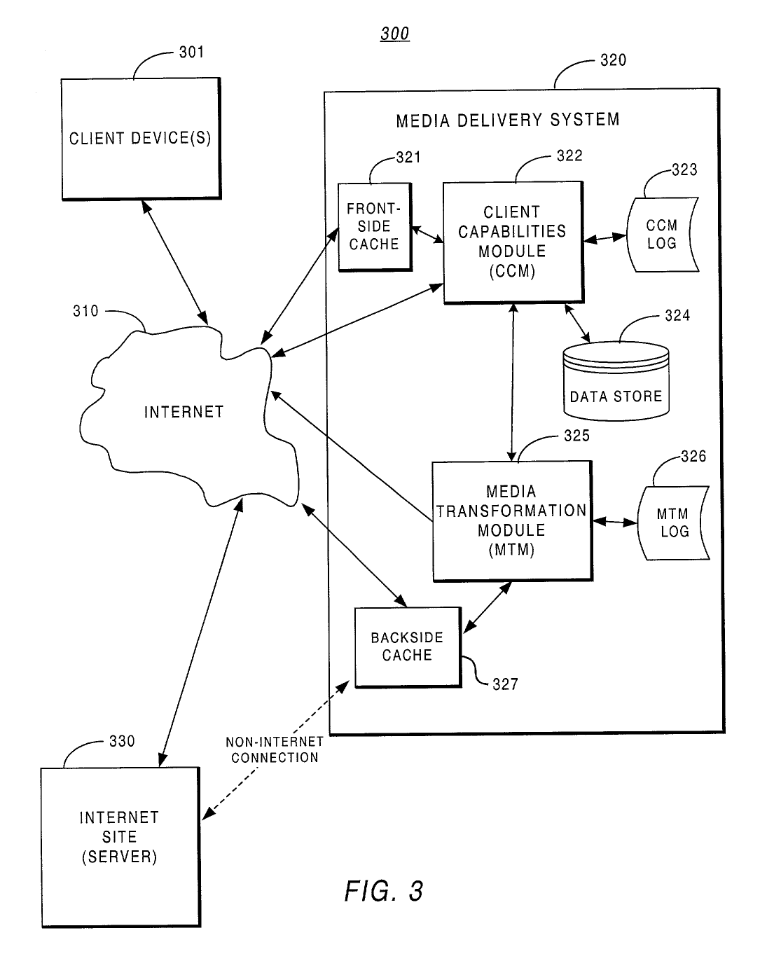

FIG. 3 illustrates an online environment 300 suitable for implementing the present invention. As shown, the environment 300 includes an online media delivery system 320 connected via the Internet (shown at 310) to one or more client devices 301 and at least one Internet site (server) 330. Each of these components will next be described in greater detail.

Client device 301 represents one of a variety of target devices (or “clients”) that are capable of connecting over the Internet and accessing online content. For example, client devices may include both wireless devices (e.g., cellular phone, handheld PDA (personal data assistant), and pager) as well as wireline devices (e.g., desktop computer, laptop computer, and videophone). Although a single client device is shown in the figure, typically the environment 300 would operate with a multitude of such devices connected.

The Internet server 330 represents a Web server at which items of media content (e.g., audio, video, documents, blob objects, or other items of interest) are stored. During operation, the Internet server 330 typically stores a number of different items of media content that are to be made available to a wide range of client devices. Actual connection between the Internet server 330 and the online media delivery system 320 may occur over the Internet or, optionally, occur via a non-Internet (e.g., WAN) connection as illustrated by the dashed connection line in the figure. In either instance, the Internet server 330 may be housed at the same site as the online media delivery system 320, or may be housed at a remote site, as desired.

The online media delivery system 320 functions to detect client device capabilities and, based on that determination, transforms and delivers media content to such devices in appropriate formats to the client device 301. As shown, the media delivery system 320 includes a client capabilities module (CCM) 322, a media transformation module (MTM) 325, and a device capabilities data store 324. As also shown, the client capabilities module 322 is in direct communication with a front-side cache 321 and a CCM log 323; the media transformation module 325, similarly, is in direct communication with backside cache 327 and MTM log 326.

2. Basic Operation

During basic system operation, items containing and/or referencing media content (e.g., Web pages) on the Internet server 330 are encoded with a URL that directs clients requesting such items to the system 320. The Internet server 330 may also include the original items of media content, which may be any type of content including digital images, video, audio, documents, “blob” objects, or the like. Alternatively, original items of media content may be stored locally on the system 320 or on another local or remote server to which the system 320 is connected. When a request (e.g., HTTP request) for an item of content is made by the client 301, the request is routed to the client capabilities module 322 of the media delivery system 320. Responsive to the request received from the client device 301, the client capabilities module 322 identifies the (client) device and obtains available information about the device's capabilities. Based on this identification, the client capabilities module 322 retrieves additional information about the capabilities of the client device for displaying or outputting media from the data store 324.

The data store 324 includes media output capabilities of various devices. In the currently preferred embodiment, a corresponding device identifier is employed to index this information. The capabilities stored in data store 324 include information regarding screen resolution, screen color depth, whether images should be rotated to fit on the device's screen display, and other such information as described in more detail below. The data store 324 is field upgradable so that as new devices are introduced into the market, the profiles of such devices and their capabilities can be added. The client capabilities log 323 includes a record of any client devices that could not be identified or for which capabilities are not available. These log records enable any omitted devices to be identified so that information on these devices can be obtained and added to the data store 324.

After the capabilities of client device 301 have been determined, client capabilities module 322 (optionally) looks into the front-side cache 321, which stores previously converted content, to see if the object is available in the appropriate format. The front-side cache 321 is an (optional) optimization in which previously converted media objects are retained for supply in response to future requests. The front-side cache 321 may be implemented using least-recently used (LRU) technique to “age out” (i.e., remove) the least-recently used items. If the client capabilities module 322 determines that the appropriate object is not available in the front-side cache 321, it requests the media transformation module 325 to perform an on-the-fly transformation that will supply the object.

The media transformation module (MTM) 325 receives requests for a particular item of media content in a particular format from client capabilities module 322. The media transformation module 325 obtains an original copy of the requested media object, converts it into the requested format, and returns the converted media object to the client device 301. The backside cache 327 is an optimization to provide increased efficiency; it may also be implemented using LRU technique. Original objects retrieved from the Internet server 330 (or another source) are retained in the backside cache 327 to avoid having to retrieve a copy of each requested item in response to each request. Use of this backside cache reduces the number of calls over the network. It also expedites conversion and return of available objects by the media transformation module 325 by avoiding the retrieval of large objects (such as high quality color images) from a remote server.

C. Methodology for Detecting Capabilities of Devices and for Delivering Appropriate Media Objects

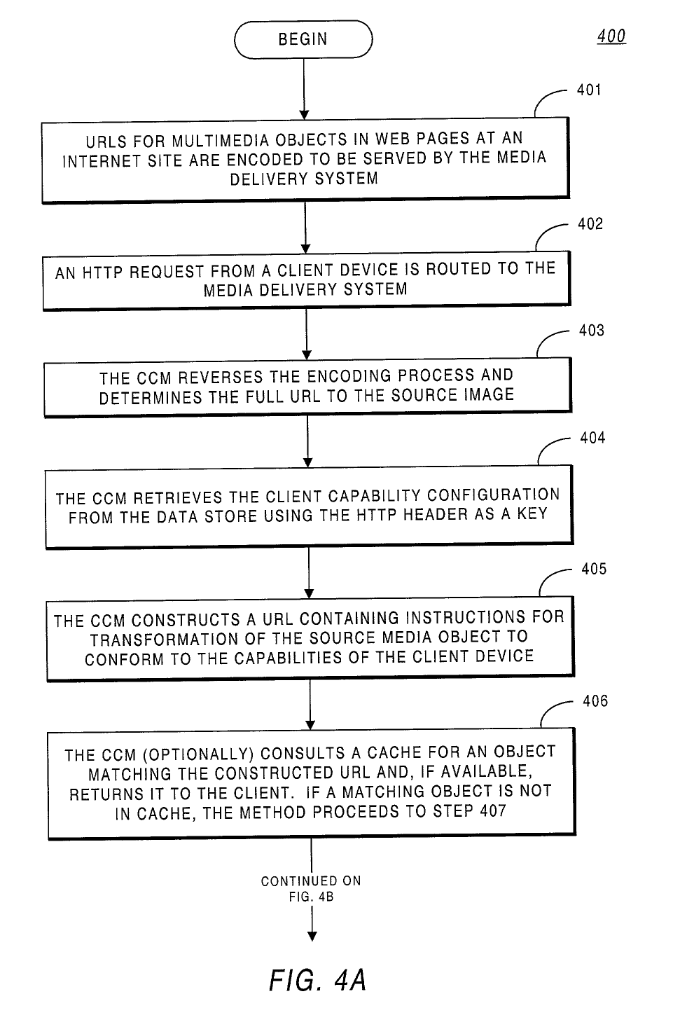

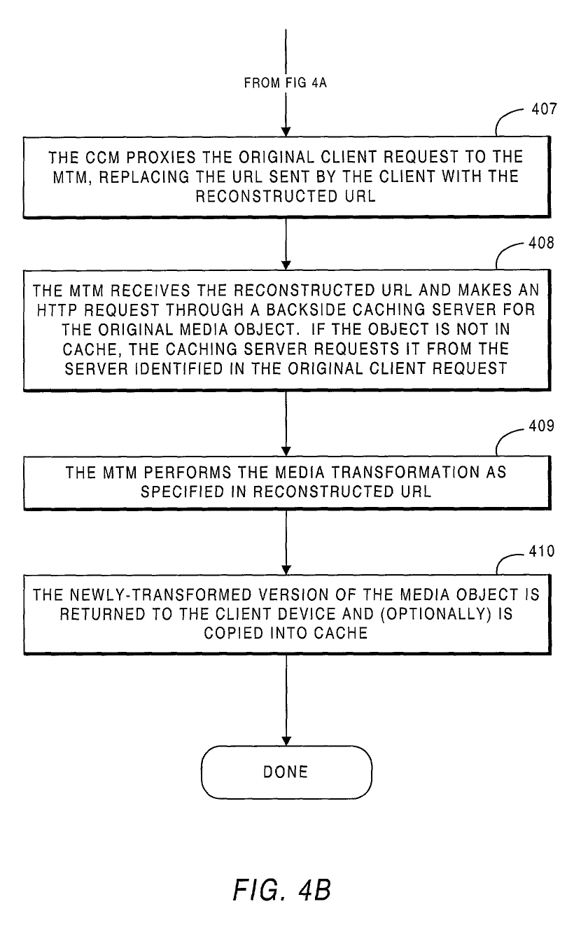

FIGS. 4A-B comprise a single flowchart of the detailed method steps of the operations of the system in detecting the capabilities of connected client devices and delivering media objects to such devices in appropriate formats. In step 401, URLs for multimedia objects in Web pages at an Internet site are modified so that such objects will be served by the media delivery system of the present invention. In the currently preferred embodiment, the URLs are prepended with the server name on which the media delivery system is installed. For example, if the subscriber's site contained a logo normally accessed by the URL: http://www.subscriber.com/img/logo.gif, the modified URL would be: http://eswitch.com/www.subscriber.com/img/logo.gif.

In step 402, an HTTP request from a client device is routed to the media delivery system when a Web page containing these rewritten URLs is opened or the client device selects (clicks on) a rewritten URL. In step 403, the client capabilities module (CCM) reverses the encoding process performed in step 401 and determines the full URL to the source image. In the currently preferred implementation, this consists of removing the “/eswitch.com” from the request URL.

In step 404, the CCM retrieves the client capability configuration from the data store using the HTTP User-Agent header as a key. The configuration information specifies the playback capabilities of the client device, such as display size, color depth, audio channels, and so forth. The configuration information may require examination of additional HTTP request headers to determine the complete capabilities of the client device. Information gathered during this step allows the CCM to understand exactly what capabilities are supported in the target device. In particular, this information indicates to the system what particular transformation operation(s) is required in order to translate the original media object into a format suitable for the target device.

In step 405, the CCM constructs a URL containing commands specific to the media transformation module (MTM). These commands instruct the MTM to transform the source media document or object to conform to the capabilities of the client device that requested the document. This URL points to the MTM server specified in the configuration file. The MTM module can be on the same server or a different server than the CCM. In (optional) step 406, the CCM consults a front-side cache for an object matching the constructed MTM URL. In other words, it looks to see if the front-side cache already stores a version of the media object that has been translated in a manner suitable for this particular target device.

In the currently preferred embodiment, the URL strings used internally within the system are encoded to serve as an index for particular object in a particular format. In this manner, an encoded URL string can indicate that a particular document in a particular format is stored at a particular location. For example the CCM can check for a URL that includes a transformed version of logo.gif with the characteristics: size=100 pixels, color depth=8, and color=false. If the document or object (translated for the target device) already exists in the front-side cache, the CCM may simply return the document to the target device. However, if a matching item is not found in the cache, then the method continues as described in step 407.

In step 407, the CCM proxies the original client request, replacing the URL sent by the client with the reconstructed URL created by the CCM. This process is completely transparent to the client: the client device making the request is not informed or aware that the request has been passed on to the MTM. Rather, this transfer is a back-end process in which the CCM forwards the request made by the client device for fulfillment by the MTM. In step 408, the MTM receives the constructed URL and makes an HTTP request through a backside-caching server for the original media object. If the object is present in the backside cache, it is served from local disk. If not, the caching server requests the object from the Internet site identified in the original URL and caches it for future use. The task of the MTM, at this point, is to transform the media object from its original format into the format that is desired for the target device (based on target device capabilities). In step 409, the MTM performs the media transformation as specified in the reconstructed URL that it received. Once the MTM has carried out this task, in step 410 the newly-transformed version of the media object is returned to the client device and (optionally) is also copied into the front-side cache.

D. Use of System to Determine and Provide Information on Client Capabilities

In addition to serving the role described above, the present invention may also be used to determine the capabilities of client devices and supply this client capabilities information to other systems or devices. For further description about how devices such as cellular phones should describe their capabilities to servers, see, e.g., WAG UAProf (Wireless Application Group User Agent Profile Specification), Wireless Application Protocol Forum, Ltd., Proposed Version May 30, 2001, available from the WAP Forum, the disclosure of which is hereby incorporated by reference. A copy of the specification can currently be found on the Internet at http://www1.wapforum.org/tech/documents/WAP-248-UAProf-20010530-p.pdf. A similar specification is described by Composite Capability/Preference Profiles (CC/PP): A user side framework for content negotiation, W3C Note, Jul 27, 1999, available from the World Wide Web Consortium (W3C), the disclosure of which is hereby incorporated by reference. A copy of the specification can be currently found on the Internet at http://www.w3.org/TR/NOTE-CCPP/.

One or both of these proposed standards may be supported by new devices and device software in the future, but current support for such standards is very limited. Until the device support of these standards is universal, server applications will not be able to take advantage of the standardized device information. This problem can be addressed by configuring the system of the present invention to act as a proxy for incoming HTTP requests from non-compliant devices. When a request is forwarded to the media delivery system with partial or no UAProf or CC/PP information, the client capabilities module looks up the required data and attaches this information to the request before forwarding the request on to its eventual destination. This enables the system to act as a bridge between the non-compliant client device and those Internet and WAP sites that require compliance with UAProf, CC/PP, or other comparable standards.

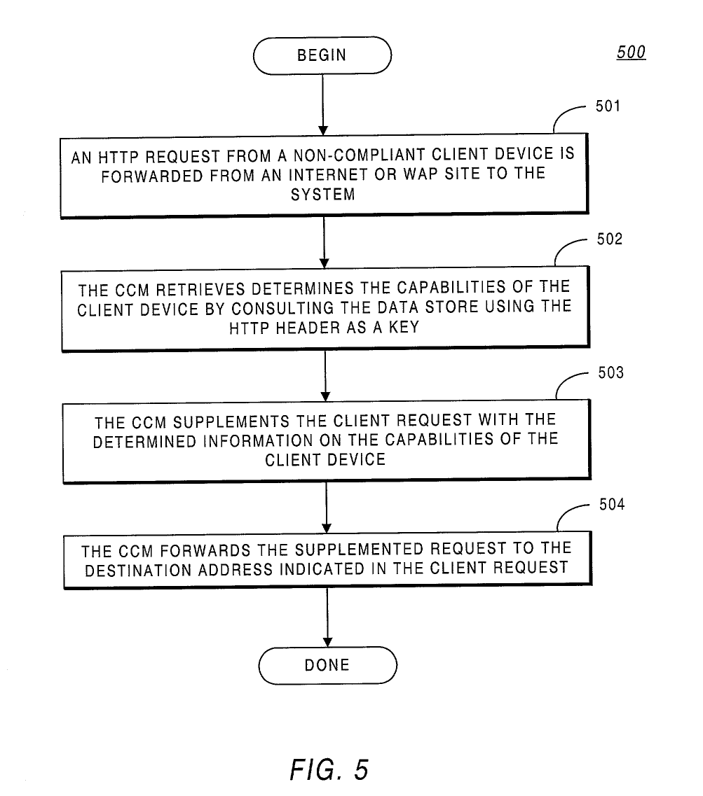

FIG. 5 is a flowchart illustrating the operations of the client capabilities module of the media delivery system in acting as a proxy for incoming HTTP requests from non-compliant devices. In step 501, an HTTP request from a non-compliant client device is forwarded from an Internet or WAP site to the system. For these purposes a “non-compliant” client device is one that is not in compliance with UAProf, CC/PP, or similar standards requiring such device to identify its capabilities.

In step 502, the system's client capabilities module (CCM) retrieves the client capability configuration from the data store using the HTTP User-Agent header as a key. The configuration information specifies the capabilities of the client device, such as display size, color depth, audio channels, and so forth. The configuration information may require examination of additional HTTP request headers to determine the complete capabilities of the client device. Information gathered during this step allows the CCM to understand exactly what capabilities are supported in the target device.

In step 503, the CCM supplements the request made by the particular client device with information regarding the specific capabilities of such client device as illustrated below. In step 504, the CCM returns the supplemented request including details on the client capabilities to the destination specified in such client request.

The following is an example of how the system can be used to append device capabilities information to a request. An example of an incoming request forwarded to the system is as follows:

GET /index.wml HTTP/1.1
Host: www.lightsurf.com
Accept-Charset: ISO-8859-1
Accept-Language: en
x-up-subno: pegli_pegli-nt4.office.lightsurf.com
x-upfax-accepts: none
x-up-uplink: none
x-up-devcap-smartdialing: 1
x-up-devcap-screendepth: 1
x-up-devcap-iscolor: 0
x-up-devcap-immed-alert: 1
x-up-devcap-numsoftkeys: 2
x-up-devcap-screenpixels: 171,108
x-up-devcap-msize: 8,18
User-Agent: UP.Browser/3.1-UPG1 UP.Link/3.2

As shown, the incoming information reports device capabilities including, for example, color support (“0” or none, for the above device) and screen pixels (171 by 108 pixels for the above device).

Following receipt of the above request, the client capabilities module determines the capabilities of the particular client device in the manner described above. The CCM then attaches this information to the request and forwards the supplemented request on to its eventual destination. A sample request showing the information appended by the CCM is as follows:

GET /index.wml HTTP/1.1
Host: www.lightsurf.com
Accept-Charset: ISO-8859-1
Accept-Language: en
User-Agent: UP.Browser/3.1-UPG1 UP.Link/3.2
x-wap-profile: http://www.eswitch.com/profiles/0A3F362B.xml

In this instance, “0A3F362B.xml” is a generated document containing either the UAProf or CC/PP profile information. A sample UAProf file for this request is as follows:

<?xml version=“1.0”/>
<RDF xmlns=“http://www.w3.org/1999/02/22-rdf-syntax-ns#”

xmlns:rdf=“http://www.w3.org/1999/02/22-rdf-syntax-ns#”

xmlns:prf=“http://www.wapform.org/profiles/UAPROF/ccppschema-
20010430#”>

<rdf:Description id=“WAP-enabled cellular phone”>

<rdf:type

resource=“http://www.wapform.org/profiles/UAPROF/ccpschema-
20010430#Hardware
Platform”/>

<prf:ScreenSize>171×108</prf:ScreenSize>
<prf:ColorCapable>No</prf:ColorCapable>
<prf:NumberOfSoftKeys>2</prf:NumberOfSoftKeys>
<prf:ScreenSizeChar>8×18</Prf:ScreenSizeChar>
...

</rdf:Description>

</RDF>

The generated document is populated with information from the device's HTTP request and the data store or knowledgebase maintained by the media delivery system. Because the system maintains a knowledgebase of client device characteristics, it is much more capable of creating a complete UAProf or CC/PP document than a server which simply transcodes the information in the HTTP headers.

E. Detailed Methods of Operation of CCM and MTM Modules

1. Client Capabilities Module

The client capabilities module (CCM) identifies a client device from an HTTP request. The CCM uses information supplied in the request, together with media output capability information stored in the data store, to determine the media output capabilities of a particular client device. This enables the CCM to determine the optimal transmission size and playback format for the particular type of client device requesting the item of interest (e.g., media object). For example, an HTTP browser may indicate the browser name (e.g., “Netscape Navigator” or “Microsoft Internet Explorer”), the browser version, and the graphic types it supports. This information is helpful in instances where graphic support is limited, such as a browser running on a set-top box having very limited graphic support (e.g., JPEG support only). In the case that the target device is not able to indicate its capabilities, it will at least indicate its device class, such as a Palm handheld device, a set-top box, a phone with a WAP browser, or the like.

Based on the device class, the CCM obtains information about the capabilities of the device from the device capabilities data store. For example, the device class may be a Palm handheld device of a particular model. Based on this information, the CCM may discern, by looking up the device class in the knowledgebase maintained in the data store, the capabilities of the device, such as display capability (e.g., 16-color), device memory (e.g., 4-8 MB), and display size (e.g., 300×500).

The CCM also includes methods to log unidentified clients in the CCM log and to provide notifications at regular intervals to ensure that the knowledgebase is as up-to-date as possible. As new client devices are introduced, the configuration information in the knowledgebase can be updated to add information on these new client devices. The CCM supports either a “push” or a “push/pull” scheme for updating its configuration files. The “push” scheme consists of a secure HTTP POST request or SMTP message sent to the data store containing the replacement configuration file. The “push/pull” scheme consists of sending an HTTP GET request or SMTP message to the data store which causes the server to schedule an update of the local configuration files.

The CCM relies primarily on HTTP headers, particularly the User-Agent header, to identify clients. The CCM also examines information in the protocol layer below HTTP (for example, the origin of the request's IP packets). Once the device has been identified, the CCM consults a hierarchical configuration file (in the data store) which supplies default values for the device's capabilities and specifies additional headers, such as the Accept header, which can also be used to determine the proper output format for media content. Once the device's capabilities have been determined, the CCM constructs a request to the MTM for the specified media document including the proper reformatting information. The CCM then forwards the client connection to the MTM with the reconstructed request.

In the currently preferred embodiment, the CCM may be implemented as an Apache module with access to the full HTTP request made by the client. The information contained in that request is used to identify the client device making the request through a series of queries against a configuration file. The HTTP User-Agent header is the primary indicator of the requesting client. While User-Agent is an optional header in both HTTP/1.0 and HTTP/1.1, in practice all Web client software send some identifying information in that header on each request. Many clients also send custom headers describing the physical capabilities of their devices. For example, the UP browser (Unwired Planet browser supplied by Openwave Systems, Inc. of Redwood City, Calif.), which is a WAP browser used in mobile phones, sends out “non-standard” heads in the request. “Non-standard” in this context means that such headers are not covered by the HTTP specification. An example of one of these headers is as follows:

User-Agent: UP.Browser/3.04-SC02 UP.Link/3.2.3.8
x-up-devcap-charset: US-ASCII
x-up-devcap-immed-alert: 1
x-up-devcap-max-pdu: 1472
x-up-devcap-msize: 8,10
x-up-devcap-numsoftkeys: 2
x-up-devcap-screenchars: 15,5
x-up-devcap-screenpixels: 120,50
x-up-devcap-smartdialing: 1
x-up-devcap-softkeysize: 7
x-up-fax-accepts: none
x-up-fax-limit: 0
x-up-subno: RzOyzSrSj-ARAs01_up2.upl.sprintpcs.com
x-up-uplink: up2.upl.sprintpcs.com

The “x-up-devcap-screenpixels” portion of the above header specifically indicates how many pixels in width and height (120×50) the client device is capable of displaying. The header shown in the above example contains several details about the capabilities of this particular client device. However, in many cases headers do not include all of these details, and thus the CCM must refer to information stored in the data store to obtain device characteristics. However, the CCM uses information in the headers like “x-up-devcap-screenpixels” portion of the above header whenever possible.

In the currently preferred implementation, the CCM configuration file (or knowledge base) in the data store is written in XML to take advantage of that language's hierarchical features. The file consists of a series of <user-agent> entries. An example <user-agent> entry might appear as follows (line numbers are for reference only):

| | |
|---|---|
| 1 | <user-agent header=‘User-Agent’ pattern=‘UP.Browser’ >> |

| | |
|---|---|
| 2 | <device-class>wap</device-class> |
| 3 | <content-type pattern=‘\hat{ }image/’> |

| | |
|---|---|
| 4 | <capability name=‘color-depth’ default=‘8’/> |
| 5 | <capability name=‘display-height’ default=‘100’> |

| | |
|---|---|
| 6 | <header name=‘x-up-devcap-screenpixels’ |

pattern=‘(\d+),\d+’/>

| | |
|---|---|
| 7 | </capability> |
| 8 | <capability name=‘display-width’ default=‘100’> |

| | |
|---|---|
| 9 | <header name=‘x-up-devcap-screenpixels’ |

pattern=‘\d+,(\d+)’/>

| | |
|---|---|
| 10 | </capability> |
| 11 | <capability name=‘output-format’ default=‘image/bmp’/> |

| | |
|---|---|
| 12 | </content-type> |

| | |
|---|---|
| 13 | </user-agent> |

In general, tag attribute naming patterns indicate that the values provided to those attributes will be treated as regular expressions. In the case where information must be extracted from the regular expression, standard “match remember” syntax (parentheses) is used. For example, on line 9 above, the pattern attribute matches the string “120, 50” and indicates that the substring “50” is to be used to set the enclosing capability value.

When the CCM receives a request, it runs through the configuration file, checking each <user-agent> tag in turn by comparing the value of the HTTP header specified by the header attribute to the string specified in the value attribute. In the majority of cases, the <user-agent> tag is matched against the HTTP User-Agent header, and matching the tag against the HTTP User-Agent header is the default behavior if the header attribute is omitted. Each <user-agent> block is processed in the order it appears in the configuration file, so <user-agent> tags with more restrictive value attributes appear before <user-agent> tags with less-restrictive value attributes. For example, a <user-agent> tag which reads value=‘UP.Browser/3.1’ is placed before a <user-agent> tag which reads value=‘UP.Browser’. The <device-class> element is used to separate the different clients into arbitrary groupings based on their capabilities. Some examples of <device-class> values might be “WAP”, “i-mode”, “HDML”, and “j-phone.”

Once a matching <user-agent> tag is found, the CCM determines the MIME type of the media document being requested, generally by issuing an HTTP HEAD request to the document source. Once the MIME type is known, the CCM looks up the appropriate <content-type> block inside the <user-agent> block. In the example above, any request for MIME types that start with “image/” will match the regular expression defined in the pattern attribute of the first <content-type> tag. An actual configuration file may have separate blocks for each supported media type or subtype.

Client capabilities are defined inside the <content-type> tag by one or more <capability> tags. Each media type may require different capabilities. To properly display images, one needs to know display width, height, and color depth. To supply appropriate audio streams, one needs to know bandwidth and whether the device is capable of playing multiple channels. In the simplest case, the configuration file provides previously-stored values for each capability through the mandatory default attribute. Lines 4 and 11 of the above example illustrate this case, setting the color depth and output format for all UP.Browser user agents to 8 bits per pixel and image/bmp, respectively. As described above, some user agents provide additional information to the server in the form of non-standard HTTP headers. The <header> tag can be used inside of a <capability> tag to instruct the CCM to parse these headers and set the device capabilities depending on the header values. In the example, line 6 indicates that the non-standard “x-up-devcap-screenpixels” header should be used, if present, to set the device display width by applying the regular expression provided in the pattern attribute to that header's value. Parentheses are used to isolate a part of the header value to assign to the capability.

Although not specifically shown above, the underlying communication transport may also be inferred from the class or type of device. For example, if the target device is a cellular phone, the system may infer that the underlying communication transport is wireless. As another example, if the target device is a pager that is communicating using WAP, the system may infer that the target device uses wireless communication with limited bandwidth (as compared to a cellular phone). Based on the device class and the incoming request, the system may usually discern whether the communication transport is wireless or wireline. Moreover, very few devices have both wireless and wireline capability. Typical wireline connections include T1, DSL, cable modem and dial-up connections. On the wireless side, typical connections include 9600-baud circuit-switched data call, 9600-baud packet-switched data call, or the newer 64K baud GPR call.

The client capabilities module is also responsible for verifying the source of the original content so that the system can only be used to reformat content of authorized participating sites and not of third parties. Security is enforced by only activating the CCM in response to specific URLs containing the name of a designated server for which content is to be transformed.

The CCM uses the information it derives about the capabilities of a particular client device to construct a request to the media transformation module for the requested media document. This CCM forwards this constructed request, including the proper reformatting information and the client connection to the MTM. The client capabilities module (optionally) implements a front-side cache for transformed media documents. This front-side cache is consulted for transformed document meeting the criteria of the constructed request before the request is forwarded to the MTM. The purpose of this front-side cache is to minimize the load on the MTM module.

2. Media Transformation Module

The media transformation (or transcoding) module (MTM) accepts HTTP requests for media documents, which contain formatting instructions as request parameters, and reformats the media according to those instructions. The MTM may specialize in a single media type, such as image or video or may support multiple types of media. In basic operation, the media transformation module supports image reformatting by: converting images both to and from the following MIME types: image/jpg, image/bmp, image/gif, image/tiff, image/wbmp, image/iff, image/pcx, and image/png; decreasing image dimensions and increasing image dimensions; supporting rotation of images to conform to the aspect ratio of the client display; and supporting decreasing image color depth and increasing of image color depth. The MTM supports audio reformatting by: converting audio files and streams both to and from the following MIME types: audio/aiff, audio/au, audio/mpeg, audio/wav; and decreasing audio bit rate.

The MTM supports video reformatting by converting video files and streams both to and from the following MIME types: video/mpeg, video/quicktime, video/x-msvideo (AVI), video/x-ms-asf, video/rm, and video/mjpeg. The MTM can also support reformatting of additional multimedia content types and streams as defined by RFC 2046, Multipurpose Internet Mail Extensions (MIME), the disclosure of which is hereby incorporated by reference. A copy of RFC 2046 is currently available on the Internet at http://www.ietf.org/rfc/rfc2046.txt.

An example of the operation of the media transformation module demonstrating its operation is set forth below. In this example, the MTM receives is translating a JPEG image and receives as input the following:

Dimensions of output (width and height);

Type of output device;

Color space (e.g., RGB or Grayscale);

Color palette (e.g., True color or indexed); and

Compression technique.

From these inputs, the MTM may output a picture in the specified output format at the specified size. Note that some devices may be characterized differently than their native characteristics. For example a device with a 16-color LCD display may prefer to be characterized as a true-color device. It is then the responsibility of the device to convert the true-color mode image transmitted by the MTM to its internal 16-color mode using internal software/hardware. Any suitable compression scheme may be employed, including proprietary or non-proprietary schemes. Examples include JPEG, JBIG, GIF, or the like. See, e.g., JPEG-like Image Compression (Parts 1 and 2), Dr. Dobb's Journal, July 1995 and August 1995 respectively (available on CD ROM as Dr. Dobb's/CD Release 6 from Dr. Dobb's Journal of San Mateo, Calif.). The disclosure of the foregoing is hereby incorporated by reference.

The specific operations of the MTM in translating the above-mentioned JPEG image are as follows. First, the input picture is decompressed to generate a bitmap in the color space that was employed. For example, Clikpix uses GUV color space; JPEG supports multiple color space, including YUV and RGB. GUV color space is described in commonly-owned application Ser. No. 09/489,511, filed Jan. 21, 2000, the disclosure of which is hereby incorporated by reference; a description of industry-standard color spaces may also be found in that application. The picture is then converted to a “standard” intermediate format, typically in one of the industry-standard color spaces. Examples include:

L,a,b 16 bits/pixel/channel (e.g., used in Adobe Photoshop);

SRGB 8 bits/pixel/channel (e.g., used by Microsoft, HP, and others); and

YUV

The intermediate format is then mapped to the format required by the output device with the following processing:

1. Image scaling—to scale the image to the desired output size.

2. If only monochrome information is desired, then a monochrome version of the image is generated using standard conversion methods (e.g., using International Telecommunication Union (ITU) recommendations for generating luminance signal Y from R, G, B signals, see, e.g.: ITU-Recommendation BT.601-1 Encoding parameters of Digital Television for studio).

3. If the bits/pixel is fewer than 8—then dithering techniques (such as error diffusion, blue noise masking, or the like—see, e.g., Recent Progress in Digital Halftoning, 1994, The Society of Imaging Science and Technology, compiled and edited by Reiner Eschbach, ISBN 0-892080-181-3).

4. If the output device has a color palette (e.g., supporting only 256 colors) then color dithering schemes are used. Such schemes are discussed in some detail in Computer Graphics—Principles and Practice, Second Edition, 1990, Foley, van Dam, et al., Addison-Wesley, Reading, Mass., ISBN 0-201-12110-7.

5. Compression is optionally performed before data is streamed out. For true-color images, the preferred compression scheme is JPEG. For indexed images GIF, PNG are the preferred methods. For halftoned images, the preferred approach is JBIG compression.

(The disclosures of the above-mentioned references are hereby incorporated by reference.)

Finally, the generated picture is outputted, and is ready for streaming to a target device for ultimate rendering on that device's display.

An example of the operations of the media transformation module in reformatting an item of media content is shown by the following “AutoRotateOp” function:

1: #include “autorotateop.h”
2:
3: AutoRotateOp::AutoRotateOp( )
4: {
5: }
6:
7: AutoRotateOp::˜AutoRotateOp ( )
8: {
9: }
10:
11: const char *AutoRotateOp::Name( )
12: {

| | |
|---|---|
| 13: | return “autorotate”; |

14: }
15:
16: const char *AutoRotateOp::Args( )
17: {

| | |
|---|---|
| 18: | return “displayWidth(160),displayHeight(120),clockwise(1)”; |

19: }
20:
21: const char *AutoRotateOp::Example( )
22: {

| | |
|---|---|
| 23: | return “autorotate=118,157”; |

24: }
25:
26: void AutoRotateOp::Process(IMG_image *img)
27: {

| | |
|---|---|
| 28: | int32 w, h, cw; |
| 29: | float displayAspect, photoAspect; |
| 30: | |
| 31: | GetArg(&w, 160); |
| 32: | GetArg(&h, 120); |
| 33: | GetArg(&cw, 1); |
| 34: | |
| 35: | displayAspect = (float)w / (float)h; |
| 36: | photoAspect = (float) (img->width) / (float) (img->height); |
| 37: | |
| 38: | if ((displayAspect > 1.0f && photoAspect < 1.0f) \|\| |

| | |
|---|---|
| 39: | (displayAspect < 1.0f && photoAspect > 1.0f)) |

| | |
|---|---|
| 40: | { |

| | |
|---|---|
| 41: | if (cw) |

| | |
|---|---|
| 42: | IMG_RotateRight(img); |

| | |
|---|---|
| 43: | else |

| | |
|---|---|
| 44: | IMG_RotateLeft(img); |

| | |
|---|---|
| 45: | } |

46: }
47:

The above AutoRotateOp function automatically rotates an image to better fit the available display of a particular device. As shown on line 26 above, the function receives a pointer to an image as a parameter. On lines 28 to 36, the display characteristics of the device are obtained. The condition on lines 38 to 39 evaluates whether or not the image should be presented in portrait orientation (i.e., to display the image vertically) or landscape orientation (i.e., to display the image horizontally) to better fit the device display. Depending on the outcome of this evaluation, a call is made to IMG RotateRight or IMG RotateLeft as shown on lines 41 to 44 and the image is rotated either clockwise or counterclockwise to fit the display of a particular device. Source code listings providing further details on the IMG RotateRight and IMG RotateLeft functions are attached hereto as Appendix A.

The MTM uses cached versions of the original media objects whenever possible. The MTM caches source media objects in the backside cache to reduce the time required to read the source media and to reduce Internet bandwidth consumption by the media delivery system. This backside caching can be performed by the MTM or by an intermediate reverse proxy cache. The source objects are cached according to the directives specified in their HTTP cache-control headers. In the currently preferred embodiment, an Apache HTTP server configured as a reverse proxy cache is deployed “between” the Internet and the MTM module, so any requests for source multimedia documents are first compared to a local disk cache. The Apache reverse proxy cache module decouples the caching task from the media transformation task for better scalability and maintainability.

Appended herewith is Computer Program Listing Appendix A containing source listings, in the C/C++ programming language, providing further description of the present invention. A suitable environment for creating and building C/C++ programs is available from a variety of vendors, including Borland® C++ Builder available from Borland Software Corporation of Scotts Valley, Calif., and Microsoft® Visual C++ available from Microsoft Corporation of Redmond, Wash.

While the invention is described in some detail with specific reference to a single-preferred embodiment and certain alternatives, there is no intent to limit the invention to that particular embodiment or those specific alternatives. For instance, those skilled in the art will appreciate that modifications may be made to the preferred embodiment without departing from the teachings of the present invention.

[image]

[image]

[image]

[image]

[image]

[image]

[image]

[image]

[image]

[image]

What is claimed is:

1. In an online system, a method for determining the capabilities of client devices and supplying media content in a format suitable for such devices, the method comprising:
receiving a request to provide a target device with a copy of a particular media object;
determining capabilities of the target device;
based on the capabilities of the target device, determining a format that is desired for providing the target device with a copy of the media object;
translating the particular media object into a copy having said determined format; and
providing the target device with the copy having said determined format.

2. The method of claim 1, further comprising
storing the copy having said determined format in a cache memory.

3. The method of claim 2, further comprising:
receiving from a target device a subsequent request for the particular object in the determined format; and
providing the target device with the copy stored in said cache memory.

4. The method of claim 1, further comprising:
obtaining a copy of said particular media object from a connected server for translation of said media object.

5. The method of claim 4, further comprising:
storing in cache memory a cached copy of said media object received from said connected server; and
in response to subsequent requests for translation of said media object, using the copy of said media object stored in cache memory.

6. The method of claim 1, wherein the capabilities of the target device include screen resolution.

7. The method of claim 1, wherein the capabilities of the target device include screen size.

8. The method of claim 1, wherein the capabilities of the target device include color support.

9. The method of claim 1, wherein the capabilities of the target device include bit rate.

10. The method of claim 1, wherein the capabilities of the target device include currently-available communication medium that the target device employs to transmit its request.

11. The method of claim 10, wherein currently-available communication medium comprises wireless communication.

12. The method of claim 10, wherein currently-available communication medium comprises wireline communication.

13. The method of claim 1, wherein said step of determining capabilities of the target device includes examining the request submitted by the device

14. The method of claim 1, wherein said step of determining capabilities of the target device includes examining the HTTP header submitted by the device.

15. The method of claim 14, wherein examining the HTTP header submitted by the device includes examining the HTTP User-Agent header.

16. The method of claim 1, wherein said step of determining capabilities of the target device includes querying the device for its capabilities.

17. The method of claim 1, wherein said step of determining capabilities of the target device includes determining capabilities from a knowledgebase, based on a device class for the target device.

18. The method of claim 17, further comprising:
recording a log record of target devices that are not recognized to enable the capabilities of said devices to be added to the knowledgebase.

19. The method of claim 18, further comprising:
automatically issuing notifications regarding said target devices that are not recognized.

20. The method of claim 1, wherein said step of determining a format that is desired includes determining an appropriate resolution for rendering the particular image at the target device.

21. The method of claim 1, wherein said step of determining a format that is desired includes determining an appropriate color space for rendering a particular image at the target device.

22. The method of claim 1, wherein said step of determining a format that is desired includes determining an appropriate image size for rendering the particular image at the target device.

23. The method of claim 1, wherein said step of determining a format that is desired includes determining whether to rotate the particular image to conform to the aspect ratio of the target device display.

24. The method of claim 1, wherein said step of determining a format that is desired includes determining the appropriate bit rate for the target device.

25. The method of claim 1, wherein said step of determining a format that is desired includes determining communication bandwidth available for transmitting a copy of the particular media object to the target device.

26. The method of claim 25, wherein the communication bandwidth available is determined, at least in part, based on the HTTP request header received from the target device.

27. The method of claim 25, wherein the communication bandwidth available is determined, at least in part, based on a device class for the target device.

28. The method of claim 1, wherein said target device includes a handheld computing device having display capability.

29. The method of claim 1, wherein said target device includes a handheld computing device having digital audio capability.

30. The method of claim 1, wherein said target device includes a cellular phone device having display capability.

31. The method of claim 1, wherein said target device includes a cellular phone device having digital audio capability.

32. The method of claim 1, wherein said target device includes a pager device having display capability.

33. The method of claim 1, wherein said target device includes a personal computer having display capability.

34. The method of claim 1, wherein said target device includes a personal computer having digital audio capability.

35. The method of claim 1, wherein said target device includes WAP (Wireless Application Protocol) support.

36. The method of claim 1, wherein said media objects include digital images.

37. The method of claim 1, wherein said digital objects include digital video.

38. The method of claim 1, wherein said digital objects include digital audio.

39. An online system for providing digital media to target devices, the system comprising:
a capabilities module for determining the capabilities of a particular target device;
a transformation module for:
automatically retrieving a copy of a particular media object; and
providing the target device with a copy of said object, said copy being automatically translated into a particular format based on the capabilities of the target device.

40. The system of claim 39, further comprising:
a cache memory for storing copies of media objects that have been translated.

41. The system of claim 40, wherein said system first attempts to satisfy the request by retrieving a copy of the particular object in the particular format from the cache memory.

42. The system of claim 39, further comprising:
a cache memory for storing copies of media objects that have been retrieved.

43. The system of claim 42, wherein said system first attempts to retrieve a copy of the particular media object from the cache memory before retrieving a copy from a remote server.

44. The system of claim 39, wherein each digital object stored by said system is identified by a unique uniform resource locator (URL).

45. The system of claim 44, wherein said unique URL is encoded with the characteristics of said digital object.

46. The system of claim 44, wherein said unique URL includes the color depth of said digital object.

47. The system of claim 44, wherein said unique URL includes the image size of said digital object.

48. The system of claim 44, wherein said unique URL includes the resolution of said digital object.

49. The system of claim 44, wherein said unique URL includes the bit rate of said digital object.

50. The system of claim 44, wherein said system stores URLs for each of the digital objects, and wherein the capabilities module is capable of determining the particular digital object that may be provided to the target device from said URLs.

51. The system of claim 39, wherein the capabilities of the target device include screen resolution.

52. The system of claim 39, wherein the capabilities of the target device include screen size.

53. The system of claim 39, wherein the capabilities of the target device include color support.

54. The system of claim 39, wherein the capabilities of the target device include bit rate.

55. The system of claim 39, wherein the capabilities of the target device include currently-available communication medium that the target device employs to transmit its request.

56. The system of claim 55, wherein currently-available communication medium comprises wireless communication.

57. The system of claim 55, wherein currently-available communication medium comprises wireline communication.

58. The system of claim 39, wherein said capabilities module includes the ability to determine the capabilities of the target device from its HTTP header.

59. The system of claim 58, wherein said capabilities module includes the ability to determine the capabilities of the target device from its HTTP User-Agent header.

60. The system of claim 39, wherein said capabilities module includes the ability to query the target device for its capabilities.

61. The system of claim 39, wherein said capabilities module includes a knowledgebase for determining the capabilities of the target device based on its device class.

62. The system of claim 61, further comprising:
a log record for recording target devices that are not recognized to enable the capabilities of said devices to be added to the knowledgebase.

63. The system of claim 39, wherein said particular format is selected based on an appropriate resolution for rendering the particular media object at the target device.

64. The system of claim 39, wherein said particular format is selected based on an appropriate color space for rendering the particular media object at the target device.

65. The system of claim 39, wherein said particular format is selected based on an appropriate image size for rendering the particular media object at the target device.

66. The system of claim 39, wherein said particular format is selected based on an appropriate bit rate for rendering the particular media object at the target device.

67. The system of claim 39, wherein said particular format is selected based on communication bandwidth available for transmitting a copy of the particular media object to the target device.

68. The system of claim 67, wherein the communication bandwidth available is determined, at least in part, based on a device class for the target device.

69. The system of claim 39, wherein said target device includes a handheld computing device having display capability.

70. The system of claim 39, wherein said target device includes a handheld device having digital audio capability.

71. The system of claim 39, wherein said target device includes a cellular phone device having display capability.

72. The system of claim 39, wherein said target device includes a cellular phone device having digital audio capability.

73. The system of claim 39, wherein said target device includes a pager device having display capability.

74. The system of claim 39, wherein said target device includes a personal computer having display capability.

75. The system of claim 39, wherein said target device includes a personal computer device having digital audio capability.

76. The system of claim 39, wherein said target device includes WAP (Wireless Application Protocol) support.

77. In an online system, a method for determining the capabilities of client devices, the method comprising:
receiving an original request from a target device in which said target device does not include information regarding its capabilities;
determining capabilities of the target device;
supplementing said original request received from said target device with information about the capabilities of said target device; and
forwarding said supplemented request to a destination specified in said original request.

78. The method of claim 77, wherein said step of determining capabilities of the target device includes examining the request submitted by the device

79. The method of claim 77, wherein said step of determining capabilities of the target device includes examining the HTTP header submitted by the device.

80. The method of claim 79, wherein examining the HTTP header submitted by the device includes examining the HTTP User-Agent header.

81. The method of claim 77, wherein said step of determining capabilities of the target device includes querying the device for its capabilities.

82. The method of claim 77, wherein said step of determining capabilities of the target device includes determining capabilities from a knowledgebase, based on a device class for the target device.
